(19) United States
(12) Patent Application Publication
(10) Pub. No.: US 2014/0238312 A1
(43) Pub. Date: Aug. 28, 2014

(54) Collar with Audio Device

(71) Applicant: Stacy Wingate, Burr Ridge, IL (US)

(72) Inventor: Stacy Wingate, Burr Ridge, IL (US)

(21) Appl. No.: 13/775,227

(22) Filed: Feb. 24, 2013

(51) Int. Cl. A01K 27/00

(52) U.S. Cl. CPC A01K 27/001
USPC 119/792

(57) ABSTRACT

A pet collar has a sound-emitting device. The device contains information about the pet, or for novelty purposes. The device may be used to record a personalized prerecorded message. The device can be used for novelty purposes such as sport team and school anthems, and desired songs. The collar is used to identify the pet, by playing the name and home address as a spoken message.

### (e) BACKGROUND OF THE INVENTION

1. Field of the Invention

This invention relates generally to collars and specifically to pet collars with an audio-emitting device.

2. Description of the Related Art

Pet collars are made of various materials and are typically adjustable in size. Pet collars have been made with a voice recognition playback device affixed thereto, such as found in US 2007/0067161 A1 by foster & Rudell. Ultrasonic sound devices are also attached to pet collars for anti-barking purposes.

There is novelty pet clothing that has sound capability, albeit limited to the technology at the time of invention. As a result, the clothing is bulky usually due to a need for a battery pack and speaker assembly within layered cloth.

There is a multiplicity of novelty items which emit spoken words, tunes, and song lyrics. A more popular recent market item is a greeting card which contains a small sound-emitting device, whereupon activation (usually by opening the card) emits song lyrics or spoken words. The sound-emitting devices typically utilized in the novelty industry, especially in the greeting cards, are surprisingly small and unnoticeable in light of the quality of sound emitted.

An object of the invention is to provide a functional, comfortable collar that emits sound. Another object of the present invention is to provide licensed pet collars which emit theme-song audio and maintain the reliability and functionality of a pet collar, such as being waterproof. Still another object of the present invention is to provide pet collars which have an ability to emit a personal pre-recorded message.

### (f) BRIEF SUMMARY OF THE INVENTION

The invention is a pet collar that has a sound-emitting device. The device, upon actuation by a user, plays a pre-determined recording. The recording is typically identification information, but can also be a novelty item by playing popular holiday music, or a college sport team anthem or alma mater song. In an alternative embodiment, the device also has recording and playback capabilities, for the purpose of replaying a personalized message.

### (g) BRIEF DESCRIPTION OF THE SEVERAL VIEWS OF THE DRAWINGS

FIG. 1 is a top view in perspective of a collar with the audio-emitting device.

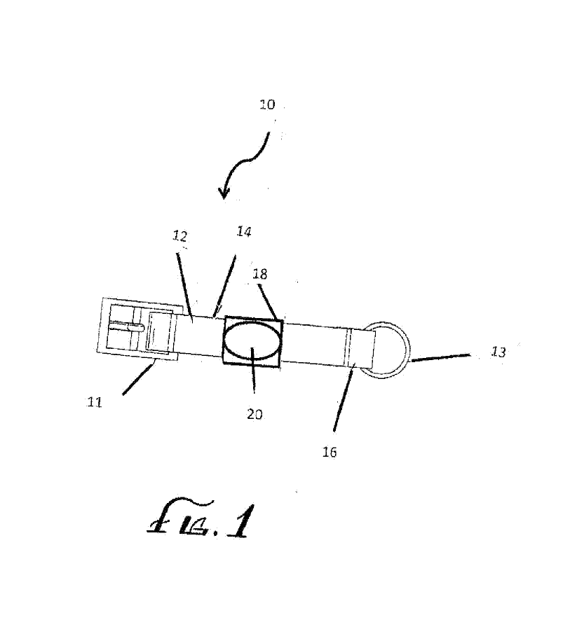

FIG. 2 is a side view of a dog wearing the inventive collar.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### (h) DETAILED DESCRIPTION OF THE INVENTION

Looking at FIG. I, this embodiment of invention displays a pet collar 10 having a first end portion 12. a medial portion 14, and a second end portion 16. The medial portion 14 extends between the first end portion 12 and the second portion 16. The collar 10 is adjustable by the use of a buckle 11 or other similar means. The collar 10 has a leash ring 13 where a walking leash attaches.

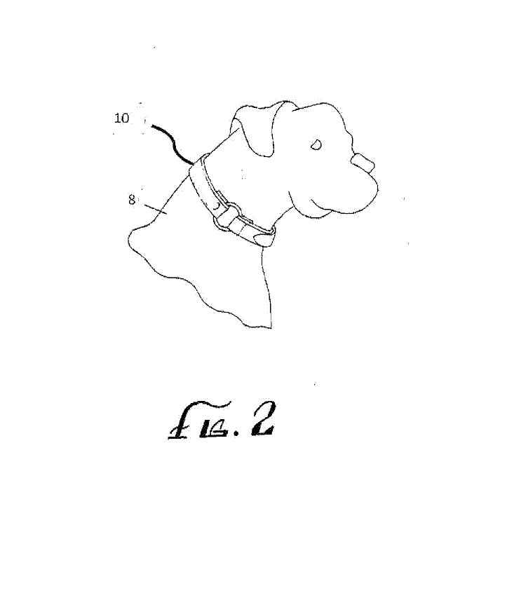

A housing 18 is secured to, the collar 10. The housing 18 is secured to one of the portions 12, 14, 16, but in the preferred embodiment, is secured to the medial portion 14. The housing 18 contains an audio-emitting device 20. The device 20 contains circuitry for generating pre-determined sounds upon actuation. For example, the device can identify the pet owner contact information, in case the pet is lost. FIG. 2 is a drawing of how the invention 10 worn by a dog 8. Also, the device 20 can be used as a novelty to play songs such as holiday tunes or sports team anthems. In another embodiment of the invention not shown, a collar could have a light-emitting means included along with a sound-emitting device.

In the preferred embodiment, the device 20 is substantially circular or oval-shaped, in order to avoid rigid or sharp edges and corners which would wear away at the collar 10. The user must actuate the device 20 in order to emit the sound. The audio-emitting device 20 is removable from the collar 10, so that the various devices are interchangeable. The audio-emitting devices 20 may be any of those standard devices in the industry, such as those utilized in novelty greeting cards and interactive holiday display decorations, which require a user to perform a task such as opening the card or pressing a button to cause the sound to be emitted. In an alternative embodiment, a device may also contain a USB port for uploading a desired sound form a web-based system and database. Finally, in still another embodiment, a device may also have recording capabilities, for the purpose of hearing a personalized message. For example, a loved one can record a message and the wearer can listen to the message emitted from his or her underwear upon activating the device.

While certain preferred embodiments of the present invention have been disclosed in detail, it, is to be understood that various modifications may be adopted without departing from the spirit of the invention or scope of the following claims.

1. A pet collar, said pet collar being used in cooperation with a conventional audio-emitting device configured to produce an audible sound when actuated, said pet collar comprising:
a first end portion, a second end portion, and a medial portion extending between said first end portion and said second end portion;
a housing secured to at least one of said portions, an audio-emitting device within said housing. said device having circuitry for generating an audible sound upon actuation;
a buckle coupled to said first end portion of said collar, said buckle being selectively securable to said second end portion of said collar whereby said collar is configured for being secured around a neck of an animal.
